(19) United States
(12) Patent Application Publication
(10) Pub. No.: US 2008/0185052 A1
(43) Pub. Date: Aug. 7, 2008

(54) SAFETY SHUT OFF VALVE FOR USE IN HYDRAULIC SYSTEM

(76) Inventor: Donald Milton Loper, Milwaukee, WI (US)

Correspondence Address: GEHRKE & ASSOCIATES, S.C., 123 N. 86th ST, WAUWATOSA, WI, 53226, US

(21) Appl. No.: 11/933,266

(22) Filed: Oct. 31, 2007

Related U.S. Application Data
(63) Continuation-in-part of application No. 11/836,302, filed on Aug. 9, 2007.
(60) Provisional application No. 60/837,600, filed on Aug. 9, 2006.

(51) Int. Cl. F15B 20/00; F16K 15/02

(52) U.S. Cl. 137/517

(57) ABSTRACT

The hydraulic system safety shut off valve is a safety valve for use immediately downstream from a hydraulic pressure power supply line and before the operational control valves and in subsystems. It includes a velocity fuse having an inlet and an outlet, a surge chamber having an inlet and an outlet, and, a connecting port, which connects the inlet outlet of the velocity fuse to the inlet of the surge chamber, the chamber for accumulation as a delay source for proving between normal operating systems and surges, and such chamber with or without such combination if necessary a return line throttle or means of creating resistance where such resistance is sensed in chamber knowing the critical nature of return line pressure to normal operation, if lost triggers the release of pressure and fluid from such chamber, thereby reducing the differential pressure against spool allowing spool to over come bias moving to close thereby immediately closing off fluid supply to system.

### CROSS-REFERENCE TO RELATED APPLICATION

This application is a continuation in part of U.S. patent application Ser. No. 11/836,302 which claims priority of U.S. Provisional Patent Application No. 60/837,600, filed Aug. 9, 2006, the contents of which is hereby incorporated by references.

### BACKGROUND OF THE INVENTION

1. Field of Invention

The present invention relates to safety valves for use in full operational hydraulic systems and sub-systems.

2. Discussion of Relevant Prior Art

Hydraulic hose and line failures in the field create an extreme hazard for operators, work crews and the environment. Injuries resulting from hydraulic lines breaks happen almost daily. Although various shut off fuses exist, none of the current designs provide a reliable and cost effective method of shutting off fluid flow when a line break occurs.

Velocity fuses are currently used for emergency shut off of fluid flow within cylinder systems. They work by sensing flow across a control orifice. When the pressure differential within the system exceeds a predetermined range, a spring biased poppet or spool closes, shutting flow to the damaged hydraulic circuit. This provides for limited protection, as the load may be protected from free falling, but the system pump is still running. Under this condition the pump continues to push high pressure fluid into atmosphere until either the machine is turned off, or pump destroys itself from lack of lubrication. A significant amount of fluid may already be lost and damage done to the operators and/or equipment. Because of this and other limitation, conventional velocity fuses are not practical as safety valves on the supply pressure side of hydraulic circuit that delivers flow to the whole operational system. Accordingly, a great need exists for a safety valve that can shut off the supply of pressurized fluid, air, water, or steam to the sub systems that has a catastrophic event where a ruptured component is venting to atmosphere.

### BRIEF SUMMARY OF THE INVENTION

The present invention is directed to a safety valve for use either immediately downstream from a hydraulic power pump and safety relief valve on the pressure supply line before the operational control valves or in working subsystems. This invention eliminates the need for expensive electronic feedback, flow, and pressure devices, by using the natural physics of fluid pressure and flow characteristics. Unlike velocity fuses currently known in the art, the valve of the present invention is not affected by flow rates or by hydraulic control valves with tandem or open center positions. Furthermore, the present invention will continue to allow flow even if the system is in a neutral position.

More specifically, the present invention is directed to a safety shut off valve comprising a velocity fuse coupled with a surge chamber, return line or a surge chamber wherein a constant back pressure is maintain with a return line. When used within a system, fluid flows through the fuse and into the adjacent surge chamber before exiting into the rest of the system. The chamber acts as an accumulator of fluid. This accumulation controls and changes the orientation of flow thus increasing differential pressure on surface of the velocity fuse which is enough to keep the fuse from prematurely shutting off during normal fluctuations in system flow. As a result, the fuse within the valve will not close until a catastrophic line rupture causes an increase in differential pressure through the drop in the chamber volume.

Furthermore, maintaining a back pressure in a return line flow downstream of subsystem, ensures that the accumulate volume and pressure within the chamber or directly against the velocity fuse will maintain the differential pressure on the surface of the spool thereby keeping the velocity fuse in an open position

The return line flow throttle can be changed in shape and size to facilitate the desired differential pressure in system. This differential load or resistance can be adjustable in shape and size through manufacturing or controlled by air, mechanical, electrical, pilot operation, by design or manually but not limited to these alone shown.

### BRIEF DESCRIPTION OF THE DRAWINGS

FIG. 1 is a cross sectional view of the safety valve in open flow position.

FIG. 2 is a cross sectional view of the safety valve in closed flow position.

FIG. 3A is view of the spool disposed in the safety valve.

FIG. 3B is an end view of the spool of FIG. 3A.

FIG. 4 is a cross sectional view of the sleeve.

FIG. 5 is a view spring.

FIG. 6 is a cross sectional view of the safety valve in the fully opened position.

FIG. 7 is a view of the safety valve in a schematic circuit.

FIG. 8A is a diagram of the throttling area.

FIG. 8B is a diagram of the throttling area with engagement of the spool.

FIG. 8C depicts the calculation of the throttling area.

FIG. 9 is a graph representing flow as related to pressure.

FIG. 10 is a figure of the safety valve including the return line.

### DETAILED DESCRIPTION OF THE INVENTION

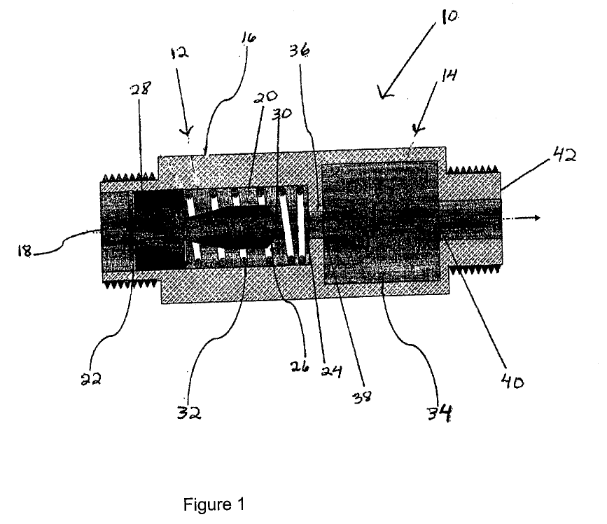

Referring now to FIG. 1, the present invention is directed to a hydraulic system safety valve 10 includes a velocity fuse 12 coupled to a surge chamber 14 which are contained within housing sleeve 16. When in use the safety valve 10 is positioned directly downstream from a hydraulic pressure power supply line and before the operational control valves or in desired subsystems. The safety valve 10 may be placed downstream of directional control valves or subsystems. When positioned within the hydraulic system, fluid flows from the system into the safety valve through inlet port 18 and enters velocity fuse chamber 20.

The velocity fuse chamber 20 is defined by chamber inlet 22 and chamber outlet 24. The chamber diameter is predetermined by the system requirements. A spool 26 having a positioning end 28 and a valve end 30 is aligned within the fuse chamber 20 so that the valve end 30 will close off the fuse chamber outlet 24 when the velocity fuse 12 is in a closed position. The spool 26 is of a diameter and length that will allow the spool 26 to slide within the fuse chamber 20 in accordance with the requirements of the system. A compression spring 32 is positioned between the valve end 30 of the spool 26 and the fuse chamber outlet 24. As fluid exits the velocity fuse chamber 20 through fuse chamber outlet 24, it enters a surge accumulator 34 via connecting port 36.

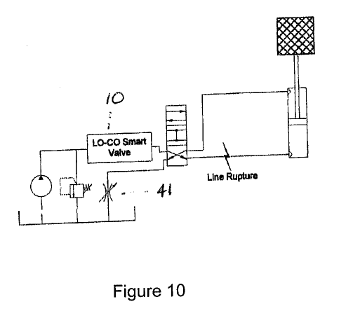

Fluid flowing through the connecting port 36 enters the accumulator 34 through a surge chamber inlet 38, and exits the accumulator 34 through a surge chamber outlet 40 which empties back into the system through valve outlet port 42. The accumulator 34 acts to disrupt and slow the flow of the fluid through the system, thereby providing a backpressure against the velocity fuse 12. As a result, normal pressure surges created during the normal operation if the hydraulic system which would typically result in a closure of a conventional velocity valve, will be damped by the backpressure created by the accumulator 34. The size and shape of the accumulator 34 will vary and will be determined by the pressure differential requirements for each system. Furthermore this differential back pressure is aided by resistance created in return line flow line, see FIG. 10. A throttle 41 is implemented in the hydraulic system. The throttle 41 may be any known type of throttling device such as check valve, small pipe or smaller diameter lines, restrictor, or adjustable valves. Although the preferred embodiment of the safety valve usage combines the chamber and return line throttle for optimizing the velocity fuse technology, the velocity fuse technology may have some improvement within a low volume, low pressure system using the chamber without a return throttle. Also, the velocity fuse technology may alternatively be used within a high volume, low pressure system using the return throttle without the chamber.

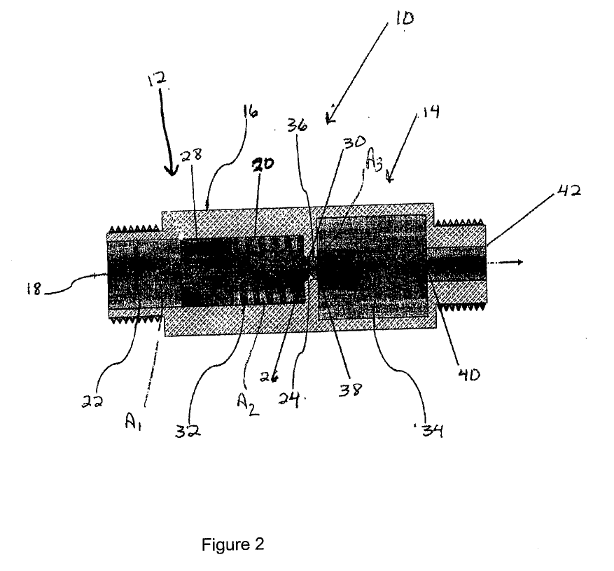

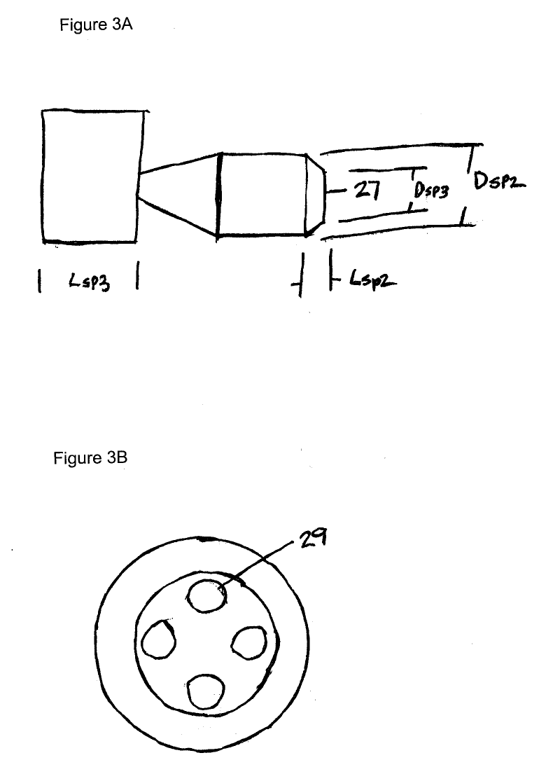

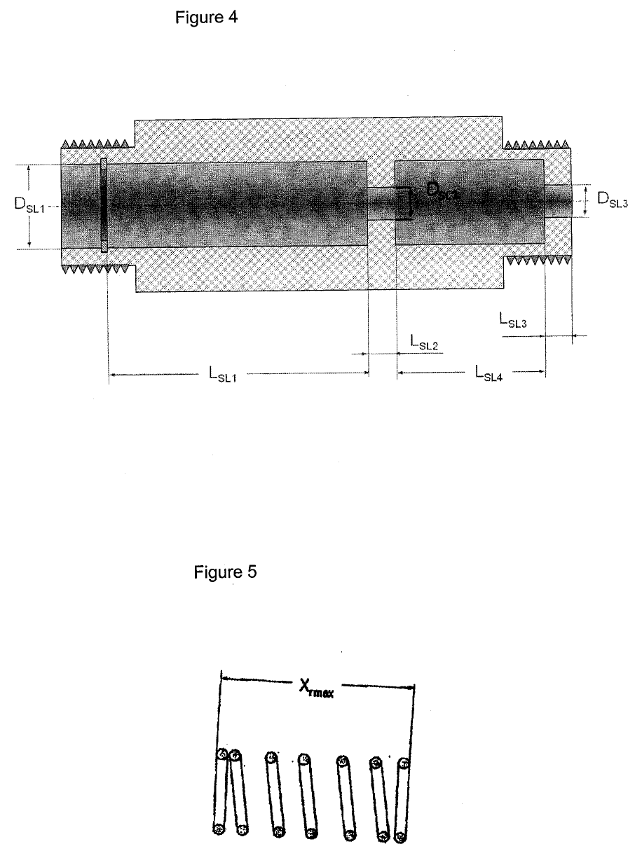

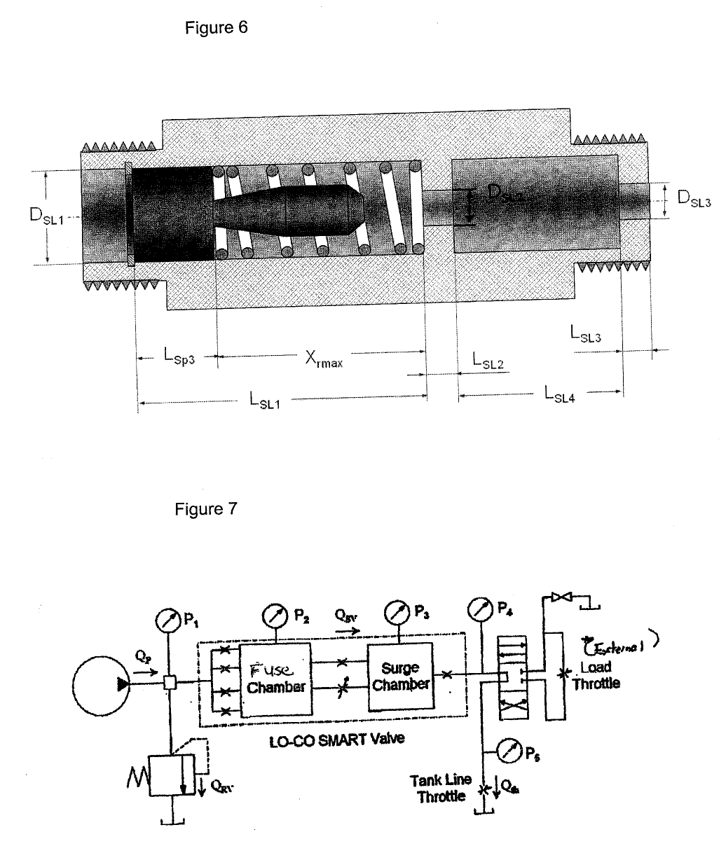

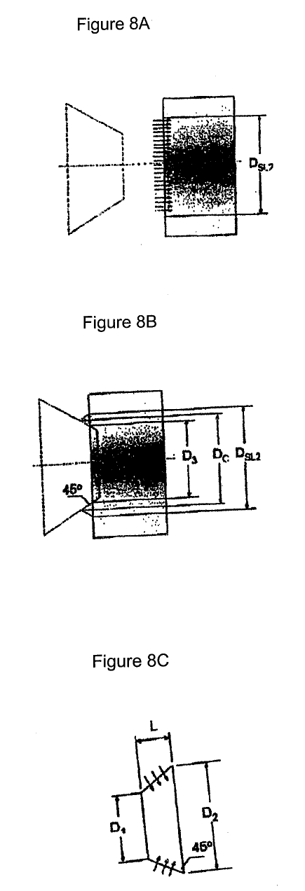

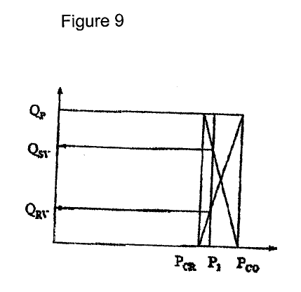

Referring now to FIG. 2, if a catastrophic line break occurs within the hydraulic system, the fluid level within the accumulator 34 of the safety valve 10 and the restrictor line will immediately drop. Consequentially, the velocity of the fluid flowing into the velocity fuse chamber 20 will slide the spool 26 against the fuse chamber outlet 24 thereby stopping the flow of fluid through the safety valve 10 and the whole hydraulic system.

Nomenclature

Δ PGeneral Pressure differences

ΔP_{DV} Pressure drop across the directional valve

ρ_{w} (Fluid) Water density

A General area

A₁ Projected area at the upstream side of the spool

A₁₂ Fixed restricted area between upstream side of the spool and the spring chamber

Λ₂ Projected area at the downstream side of the spool

Λ₂₃ Variable restricted area at the entrance of the surge chamber

Λ₃ Spool face projected area when the spool advancing in the entrance hole of the surge chamber

A₃₄ Fixed restricted area at the outlet of the surge chamber

Aₜₕ Throttling area of the tank line throttle

B Fluid bulk Modulus

C_{d} Discharge coefficient

D_{SL1} Sleeve geometrical diameter

D_{SL2} Sleeve geometrical diameter

D_{sL3} Sleeve geometrical diameter

D_{SP1} Spool geometrical diameter

D_{SP2} Spool geometrical diameter

D_{SP3} Spool geometrical diameter

D_{SP4} Spool geometrical diameter

P₅ (P_{Pump}) Back pressure before tank line throttle

P_{co} Relief valve dead head pressure

P_{CR} Relief valve cracking pressure

P_{RL} Pressure equivalent to the external load

Q General Flow rate

Q₃₄ Flow from surge chamber to the system

Q_{P} Flow source (from the pump)

Q_{RV} Flow through the relief valve

Q_{SV} Flow into surge chamber from the spring chamber

Qₜₕ Flow through tank line throttle valve

S (Sₘₐₓ) Instantaneous (maximum) spool displacement

S′ Spool velocity

S″ Spool acceleration

SG Fluid specific gravity

Vₛ Volume of the surge chamber

Xₘₐₓ Spring maximum (Free) length

If the spool face 27 is blocking the entrance of connecting port 36 the variable orifice is considered closed. If the spool face 27 is completely out of contact with the entrance connecting port 36 the variable orifice is considered open.

The following very well know equation will be used to describe the nonlinear relation between the differential pressure across any sharp-edged short orifice and the flow rate passing through it.

Q=C_{d}A(2ΔP/SG*ρ_{w})^{1/2}

This equation can be mathematically manipulated and rewritten to get one constant using as follows.

Q[gpm]=22.85×A[in²] (ΔP [psi]/SG)^{1/2}

This can be used to find the differential pressure in terms of the flow rate.

Δ P [psi]=SG×Q²[gpm]²/22.85×A²[in²]²

By applying this equation on the return tank line throttle and neglecting the flow resistance in the hydraulic line between the throttle and the tank, pressure P₅ is found as follows.

P₅=SG×Qₜₕ²/22.85²×Aₜₕ²

Fluid flow through the tank line throttle equals the safety valve 10 flow Q_{SV} in this case and if a hydraulic motor is used. If a differential cylinder is used, ratio must be considered in calculating the return flow.

The tank line throttling area is a simple variable circular area function of the throttle diameter as follows.

Aₜₕ=πD²ₜₕ/4

Pressure in the fuse chamber 20 is calculated by the following equation, P₂=P₃+(SG×Q_{SV}²)/(22.85²×A₂₃²) wherein A₂₃ is the throttling area between the fuse chamber and surge volume.

The return line throttle 41 is considered to be any controlled, uncontrolled, or design feature that creates for the purpose of operation control of any type which valve operates on such needed restriction or back pressure. This is by no means the only way to create back pressure and can be created for reasons of control. Mechanical, electrical, air, pilot pressure, may be used as may other methods internal or external.

During a line rupture, load pressure suddenly is released to the atmospheric pressure and the pressure in the return line becomes zero. Consequentially, the safety valve 10 immediately shuts off supply pressure upstream wherever it is located in system, as discussed above. In this condition, a surge flow is developed at the upstream side of the valve spool 10 and drives it to reach its saturation limit and shuts off the pump flow supply line. Accordingly, pump pressure increases to the relief valve setting. This protects pump, personal, equipment, and environment. In some circumstances it may not be necessary for a return line throttle, as the internal resistance of return line can be designed for optimized operation. In such a case, safety valve 10 is then kept open as in normal pump unloading conditions using the surge chamber and the tank line pressure optimized to achieve this situation.

Once operating pressure is removed from valve 10, the spring 32 returns spool 26 back to its beginning position normal operation by such spring 32. Once a line break is repaired the safety valve 10 has already reset itself to normal operating position without any need of adjustment.

In use, the safety valve 10 is able to remain open in steady state loading conditions and unloading conditions. When the load pressure suddenly drops to atmospheric pressure (a state simulating a line rupture), a surge flow is developed at the upstream side of the spool that drives it to reach its saturation limit and shutoff the pump flow.

Any velocity fuse can be used if the differential pressure is maintained by either the accumulator chamber 34 or the restrictor line. Preferably, the accumulator chamber 34 is used in combination with the restrictor line.

While we have shown and described the preferred embodiments of my invention, it will be understood that the invention may be embodied otherwise than as herein specifically illustrated or described, and that certain changes in form and arrangement of parts and the specific manner of practicing the invention may be made within the underlying idea or principles of the invention.

I claim:

1. A hydraulic system comprising:
a hydraulic pressure power supply line;
at least one operational control valve; and
a hydraulic system safety valve positioned between the hydraulic pressure power supply and at least one operational control valve;
wherein said hydraulic system safety valve prevents fluid flow depending on a pressure in said hydraulic pressure power supply line.

2. The hydraulic system of claim 1, wherein the hydraulic safety valve comprises:
a velocity fuse having an inlet and an outlet;
a surge chamber having an inlet and an outlet; and,
a connecting port which connects the inlet outlet of the velocity fuse to the inlet of the surge chamber.

3. The hydraulic system of claim 2, wherein the hydraulic safety valve comprises fixed and variable orifices.

4. The hydraulic system of claim 2 wherein:
Said surge chamber acts to disrupt and slow the flow of the fluid through the hydraulic system, thereby providing a backpressure against the velocity fuse.

5. They hydraulic system of claim 1 further comprising:
a means of controlling differential pressure in a return line.

6. The hydraulic system of claim 4 wherein:
said controlling means is one of a smaller diameter line, check valve, restrictor, and an adjustable valve.

7. A method of closing off fluid supply to system of hydraulic system having a return line comprising:
providing a hydraulic pressure power supply line having at least one operational control valve; and
employing a hydraulic system safety valve positioned between the hydraulic pressure power supply and at least one operational control valve; and,
closing a hydraulic safety valve when the back pressure in the return line of the said hydraulic system safety valve is lost following a rupture in said hydraulic system.

8. The method of claim 6 further comprising:
employing a restrictor in said return line.

9. The method of claim 6 wherein:
the hydraulic safety valve comprises a velocity fuse having an inlet and an outlet, a surge chamber having an inlet and an outlet, and a connecting port which connects the inlet outlet of the velocity fuse to the inlet of the surge chamber.

10. The method of claim 8, wherein the hydraulic safety valve comprises fixed and variable orifices.
